(19) United States
(12) Patent Application Publication
(10) Pub. No.: US 2026/0186243 A1
(43) Pub. Date: Jul. 2, 2026

(54) CAMERA OPTICAL LENS

(71) Applicant: Changzhou AAC Raytech Optronics Co., Ltd., Changzhou City (CN)

(72) Inventors: Yuyi Liu, Changzhou (CN); Shunda Zhou, Changzhou (CN)

(21) Appl. No.: 19/342,641

(22) Filed: Sep. 28, 2025

Related U.S. Application Data
(63) Continuation of application No. PCT/CN2025/070073, filed on Jan. 2, 2025.

(51) Int. Cl. G02B 9/60

(52) U.S. Cl. CPC G02B 9/60

(57) ABSTRACT

Provided is a camera optical lens, including five lenses. An on-axis distance from an image side surface of the second lens to an object side surface of the third lens is d4, an on-axis distance from an image side surface of the third lens to an object side surface of the fourth lens is d6, a central curvature radius of an object side surface of the second lens is R3, a central curvature radius of the image side surface of the second lens is R4, a central curvature radius of an object side surface of the fifth lens is R9, and a central curvature radius of an image side surface of the fifth lens is R10, and following relational expressions are satisfied: 3.00≤d6/d4≤6.00; −2.00≤R9/R10≤−0.80; and 1.70≤(R3+R4)/(R3−R4)≤2.50. The camera optical lens has excellent optical characteristics, as well as large aperture and ultra-thin characteristics.

### TECHNICAL FIELD

The present disclosure relates to the field of optical lenses, and in particular, to a camera optical lens suitable for handheld terminal devices such as smart phones and digital cameras, and camera apparatus such as monitors and PC lenses.

### BACKGROUND

In recent years, with the rise of various smart devices, the demand for a miniaturized camera optical lens has gradually increased. Moreover, since the pixel size of a photosensitive device is reduced, and the current electronic product has a development trend towards having good functions and an appearance of thin, light and portable, the miniaturized camera optical lens having good imaging quality has become a mainstream in the current market. In order to obtain better imaging quality, a multi-lens structure is mostly adopted. In addition, with the development of technology and the increase of diversified requirements of users, under the conditions that a pixel area of the photosensitive device continues to reduce and the requirement on the imaging quality of the system are continuously improving, a nine-lens structure has been gradually adopted in the lens design. There is an urgent need for a long-focus camera lens with excellent optical characteristics, small size, and sufficiently corrected aberrations.

### SUMMARY

In view of the above problems, a main object of the present disclosure is to provide a camera optical lens, which has good optical performance and meets design requirements of small chromatic aberration, small distortion and ultra-thin.

In order to achieve the above object, an embodiment of the present disclosure provides a camera optical lens, including five lenses from an object side to an image side: a first lens having a positive refractive power, a second lens having a negative refractive power, a third lens having a negative refractive power, a fourth lens having a negative refractive power, and a fifth lens having a positive refractive power. An on-axis distance from an image side surface of the second lens to an object side surface of the third lens is d4, an on-axis distance from an image side surface of the third lens to an object side surface of the fourth lens is d6, a central curvature radius of an object side surface of the second lens is R3, a central curvature radius of the image side surface of the second lens is R4, a central curvature radius of an object side surface of the fifth lens is R9, and a central curvature radius of an image side surface of the fifth lens is R10, and following relational expressions are satisfied: 3.00≤d6/d4≤6.00; −2.00≤R9/R10≤−0.80; and 1.70≤(R3+R4)/(R3−R4)≤2.50.

As an improvement, an Abbe number of the first lens is v1, and a following relational expression is satisfied: 60.00≤v1≤82.00.

As an improvement, a focal length of the third lens is f3, and a focal length of the fourth lens is f4, and a following relational expression is satisfied: 1.20≤f3/f4≤2.40.

As an improvement, an object side surface of the first lens is convex in a paraxial region, and an image side surface of the first lens is convex in the paraxial region. A focal length of the camera optical lens is f, a focal length of the first lens is f1, a central curvature radius of the object side surface of the first lens is R1, a central curvature radius of the image side surface of the first lens is R2, an on-axis thickness of the first lens is d1, and a total track length of the camera optical lens is TTL, and following relational expressions are satisfied: 0.38≤f1/f≤0.48; −0.85≤(R1+R2)/(R1−R2)≤−0.81; and 0.140≤d1/TTL≤0.168.

As an improvement, an object side surface of the second lens is convex in a paraxial region, and an image side surface of the second lens is concave in the paraxial region. A focal length of the camera optical lens is f, a focal length of the second lens is f2, an on-axis thickness of the second lens is d3, and a total track length of the camera optical lens is TTL, and following relational expressions are satisfied: −1.09≤f2/f≤−0.59; and 0.026≤d3/TTL≤0.035.

As an improvement, an object side surface of the third lens is convex in a paraxial region, and an image side surface of the third lens is concave in the paraxial region. A focal length of the camera optical lens is f, a focal length of the third lens is f3, a central curvature radius of the object side surface of the third lens is R5, a central curvature radius of the image side surface of the third lens is R6, an on-axis thickness of the third lens is d5, and a total track length of the camera optical lens is TTL, and following relational expressions are satisfied: −1.10≤f3/f≤−0.81; 1.03≤(R5+R6)/(R5−R6)≤1.25; and 0.022≤d5/TTL≤0.047.

As an improvement, an object side surface of the fourth lens is concave in a paraxial region, and an image side surface of the fourth lens is concave in the paraxial region. A focal length of the camera optical lens is f, a focal length of the fourth lens is f4, a central curvature radius of the object side surface of the fourth lens is R7, a central curvature radius of the image side surface of the fourth lens is R8, an on-axis thickness of the fourth lens is d7, and a total track length of the camera optical lens is TTL, and following relational expressions are satisfied: −0.63≤f4/f≤−0.49; −0.69≤(R7+R8)/(R7−R8)≤−0.33; and 0.034≤d7/TTL≤0.045.

As an improvement, an object side surface of the fifth lens is convex in a paraxial region, and an image side surface of the fifth lens is convex in the paraxial region. A focal length of the camera optical lens is f, a focal length of the fifth lens is f5, a central curvature radius of the object side surface of the fifth lens is R9, a central curvature radius of the image side surface of the fifth lens is R10, an on-axis thickness of the fifth lens is d9, and a total track length of the camera optical lens is TTL, and following relational expressions are satisfied:

$$0.57 \leq f 5 / f \leq 0.84 ; - 0.11 \leq ( R 9 + R 10 ) / ( R 9 - R 10 ) \leq 0.34 ; \\ and 0.095 \leq d 9 / TTL \leq 0.105 .$$

As an improvement, an F-number of the optical camera lens is FNO, and a following relational expression is satisfied: 2.45≤FNO≤2.77.

As an improvement, the first lens is made of glass.

As an improvement, a focal length of the third lens is f3, and a focal length of the fourth lens is f4, and a following relational expression is satisfied: 1.30≤f3/f4≤2.20.

The present disclosure has the following beneficial effects: the camera optical lens according to the present disclosure has excellent optical characteristics, as well as large aperture and ultra-thin characteristics, and is particularly suitable for a mobile phone camera lens assembly and a WEB camera lens composed of camera elements such as CCD and CMOS with high resolution.

### BRIEF DESCRIPTION OF DRAWINGS

In order to better illustrate the technical solutions in embodiments of the present disclosure, the drawings used in the description of the embodiments will be briefly described below. It is appreciated that, the drawings in the following description are only some embodiments of the present disclosure, and for those skilled in the art, other drawings may also be obtained according to these drawings without creative effort.

FIG. 1 is a schematic structural diagram of a camera optical lens according to a first embodiment of the present disclosure;

FIG. 2 is a schematic diagram of longitudinal aberration of the camera optical lens shown in FIG. 1;

FIG. 3 is a schematic diagram of lateral color of the camera optical lens shown in FIG. 1;

FIG. 4 is a schematic diagram of field curvature and distortion of the camera optical lens shown in FIG. 1;

FIG. 5 is a schematic structural diagram of a camera optical lens according to a second embodiment of the present disclosure;

FIG. 6 is a schematic diagram of longitudinal aberration of the camera optical lens shown in FIG. 5;

FIG. 7 is a schematic diagram of lateral color of the camera optical lens shown in FIG. 5;

FIG. 8 is a schematic diagram of field curvature and distortion of the camera optical lens shown in FIG. 5;

FIG. 9 is a schematic structural diagram of a camera optical lens according to a third embodiment of the present disclosure;

FIG. 10 is a schematic diagram of longitudinal aberration of the camera optical lens shown in FIG. 9;

FIG. 11 is a schematic diagram of lateral color of the camera optical lens shown in FIG. 9;

FIG. 12 is a schematic diagram of field curvature and distortion of the camera optical lens shown in FIG. 9;

FIG. 13 is a schematic structural diagram of a camera optical lens according to a fourth embodiment of the present disclosure;

FIG. 14 is a schematic diagram of longitudinal aberration of the camera optical lens shown in FIG. 13;

FIG. 15 is a schematic diagram of lateral color of the camera optical lens shown in FIG. 13;

FIG. 16 is a schematic diagram of field curvature and distortion of the camera optical lens shown in FIG. 13;

FIG. 17 is a schematic structural diagram of a camera optical lens according to a comparative embodiment;

FIG. 18 is a schematic diagram of axial aberration of the camera optical lens shown in FIG. 17;

FIG. 19 is a schematic diagram of lateral color of the camera optical lens shown in FIG. 17; and

FIG. 20 is a schematic diagram of field curvature and distortion of the camera optical lens shown in FIG. 17.

### DESCRIPTION OF EMBODIMENTS

In order to better illustrate objectives, technical solutions, and advantages of embodiments of the present disclosure, the technical solutions in the embodiments of the present disclosure are clearly and completely described in details with reference to the drawings. Those of ordinary skill in the art will appreciate that in various embodiments of the present disclosure, numerous technical details are set forth for the reader to better understand the present disclosure. However, even without these technical details and various variations and modifications based on the following embodiments, the technical solutions claimed in the present disclosure can still be implemented.

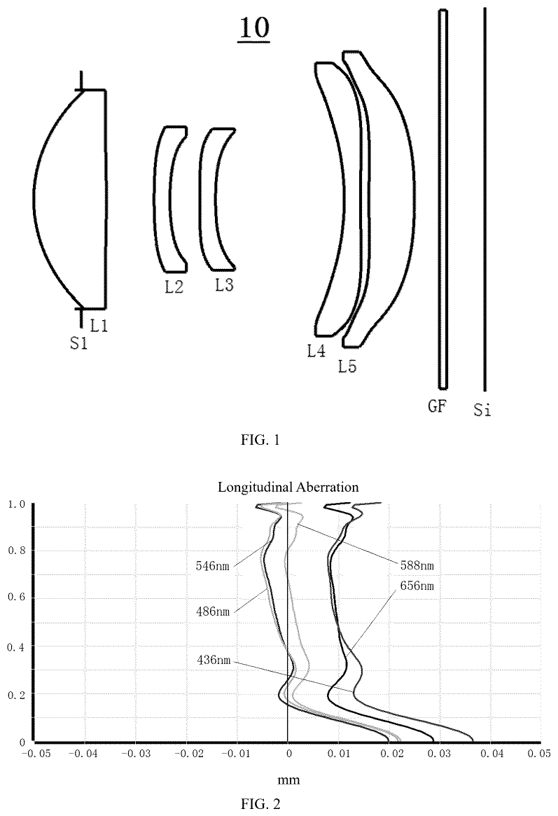

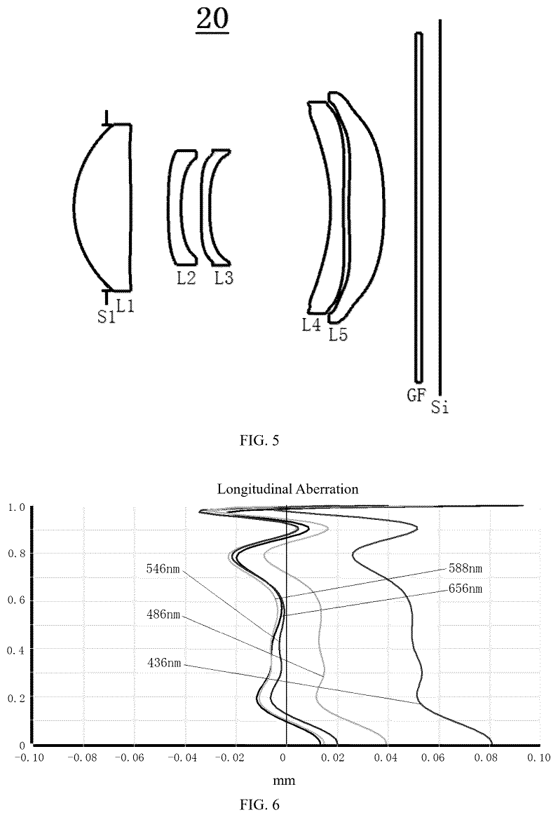

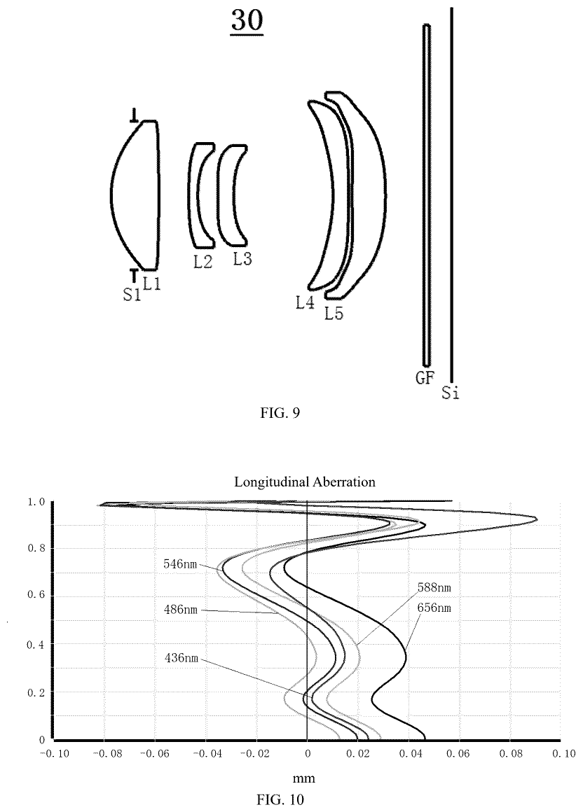

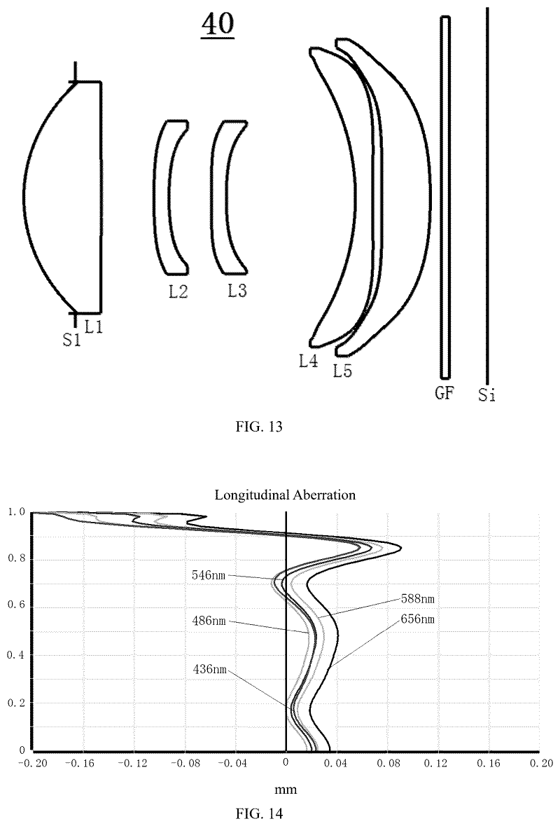

Referring to the drawings, embodiments of the present disclosure provide a camera optical lens 10, 20, 30 and 40. FIG. 1, FIG. 5, FIG. 9, and FIG. 13 show a camera optical lens 10, 20, 30, and 40 according to the present disclosure, and the camera optical lens 10, 20, 30, and 40 includes five lenses. The camera optical lens includes from an object side to an image side: an aperture S1, a first lens L1, a second lens L2, a third lens L3, a fourth lens L4, and a fifth lens L5. An optical element such as a grating filter GF may be provided between the fifth lens L5 and an image plane S1.

The first lens L1 is made of glass, the second lens L2 is made of plastic, the third lens L3 is made of plastic, the fourth lens L4 is made of plastic, and the fifth lens L5 is made of plastic. Each lens may also be made of other materials.

An on-axis distance from the image side surface of the second lens L2 to the object side surface of the third lens L3 is defined as d4, and an on-axis distance from the image side surface of the third lens L3 to the object side surface of the fourth lens L4 is defined as d6, and the following relational expression is satisfied: 3.00≤d6/d4≤6.00. This relational expression specifies the ratio of the air gap between the third lens and the fourth lens to the air gap between the second lens and the third lens. Within the range of the relational expression, it helps to reduce the total track length of the optical system.

A central curvature radius of the object side surface of the fifth lens is defined as R9, and a central curvature radius of the image side surface of the fifth lens is defined as R10, and the following relational expression is satisfied: −2.00≤R9/R10≤−0.80. This relational expression defines the shape of the fifth lens. Within the range of the relational expression, it is beneficial to reduce the degree of deflection of light passing through the lens, thereby effectively correcting the chromatic aberration, and making the chromatic aberration |LC|≤6.0 μm.

A central curvature radius of the object side surface of the second lens is defined as R3, and a central curvature radius of the image side surface of the second lens is defined as R4, and the following relational expression is satisfied: 1.70≤(R3+R4)/(R3−R4)≤2.50. This relational expression defines the shape of the second lens. The astigmatism and distortion of the camera lens are corrected, making the distortion |Distortion|≤2.5%, thereby reducing the possibility of vignetting.

When the above relational expressions are satisfied, the camera optical lens 10, 20, 30 and 40 has good optical performance and can satisfy the design requirements of large aperture and ultra-thin. According to the characteristics of the camera optical lens 10, 20, 30 and 40, the camera optical lens 10, 20, 30 and 40 is particularly suitable for the mobile phone camera lens assembly and the WEB camera lens composed of camera elements such as CCD and CMOS with high resolution.

Based on the above relational expressions and the achievable functions, the characteristics of each lens are further defined as follows.

An Abbe number of the first lens is defined as v1, and the following relational expression is satisfied: 60.00≤v1≤82.00. This relational expression specifies the Abbe number of the first lens L1. Within the range of the relational expression, material properties can be effectively distributed, and the chromatic aberration can be effectively corrected, making the chromatic aberration |LC|≤6.0 μm.

A focal length of the third lens is defined as f3, and a focal length of the fourth lens is defined as f4, and the following relational expression is satisfied: 1.20≤f3/f4≤2.40. This relational expression specifies the ratio of the focal length of the third lens to the focal length of the fourth lens. The system has better imaging quality and lower sensitivity by reasonably distributing the optical focal length of the system. Optionally, 1.30≤f3/f4≤2.20.

The object side surface of the first lens L1 is convex in a paraxial region, and the image side surface of the first lens L1 is convex in the paraxial region. The first lens L1 has a positive refractive power. The object side surface and the image side surface of the first lens L1 may also be configured with other concave and convex arrangements.

A focal length of the camera optical lens 10 is defined as f, and a focal length of the firstlens L1 is defined as f1, and the following relational expression is satisfied: 0.38≤f1/f≤0.48. This relational expression specifies the ratio of the positive refractive power of the first lens L1 to the overall focal length. Within the specified range, the first lens has a proper positive refractive power, which is beneficial to reducing the system aberration, and is beneficial to the development of the lens assembly to ultra-thin.

A central curvature radius of the object side surface of the first lens L1 is R1, and a central curvature radius of the image side surface of the first lens L1 is R2, and the following relational expression is satisfied: −0.85≤(R1+R2)/(R1−R2)≤−0.81. The spherical aberration of the system can be effectively corrected by reasonably controlling the surface shape of the first lens L1.

An on-axis thickness of the first lens L1 is d1, and a total track length of the camera optical lens 10 is TTL, and the following relational expression is satisfied: 0.140≤d1/TTL≤0.168. Within the range of the relational expression, it is beneficial to achieve ultra-thin property.

An object side surface of the second lens L2 is convex in a paraxial region, and an image side surface of the second lens L2 is concave in the paraxial region. The second lens L2 has a negative refractive power.

The object side surface and the image side surface of the second lens L2 may also be configured with other concave and convex arrangements.

A focal length of the second lens L2 is f2, and the following relational expression is satisfied: −1.09≤f2/f≤−0.59. By controlling the negative refractive power of the second lens L2 within a reasonable range, it is beneficial to correct the aberration of the optical system.

An on-axis thickness of the second lens L2 is d3, and the following relational expression is satisfied: 0.026≤d3/TTL≤0.035. Within the range of relational expression, it is beneficial to achieve ultra-thin property.

An object side surface of the third lens L3 is convex in a paraxial region, and an image side surface of the third lens L3 is concave in the paraxial region. The third lens L3 has a negative refractive power. The object side surface and the image side surface of the third lens L3 may also be configured with other concave and convex arrangements.

A focal length of the third lens L3 is f3, and the following relational expression is satisfied: −1.10≤f3/f≤−0.81. The system can achieve better imaging quality and lower sensitivity through reasonable distribution of the refractive power.

A central curvature radius of the object side surface of the third lens L3 is R5, and a central curvature radius of the image side surface of the third lens L3 is R6, and the following relational expression is satisfied: 1.03≤(R5+R6)/(R5−R6)≤1.25. This relational expression defines the shape of the third lens L3, and is beneficial to the molding of the third lens L3. Within the range specified by the relational expression, the deflection degree of light passing through the lens can be reduced, thereby effectively reducing the aberrations.

An on-axis thickness of the third lens L3 is d5, and the following relational expression is satisfied: 0.022≤d5/TTL≤0.047. Within the range of relational expression, it is beneficial to achieve ultra-thin property.

An object side surface of the fourth lens L4 is concave in a paraxial region, and an image side surface of the fourth lens L4 is concave in the paraxial region. The fourth lens L4 has a negative refractive power. The object side surface and the image side surface of the fourth lens L4 may also be configured with other concave and convex arrangements.

A focal length of the fourth lens L4 is f4, and the following relational expression is satisfied: −0.63≤f4/f≤−0.49. The system has better imaging quality and lower sensitivity through reasonable distribution of the refractive power.

A central curvature radius of the object side surface of the fourth lens L4 is R7, and a central curvature radius of the image side surface of the fourth lens L4 is R8, and the following relational expression is satisfied: −0.69≤(R7+R8)/(R7−R8)≤−0.33. This relational expression defines the shape of the fourth lens L4. Within the range of the relational expression, it is beneficial to correct the problems such as the aberration of off-axis angles.

An on-axis thickness of the fourth lens L4 is d7, and the following relational expression is satisfied: 0.034≤d7/TTL≤0.045. Within the range of relational expression, it is beneficial to achieve ultra-thin property.

An object side surface of the fifth lens L5 is convex in a paraxial region, and an image side surface of the fifth lens L5 is convex in the paraxial region. The fifth lens L5 has a positive refractive power. The object side surface and the image side surface of the fifth lens L5 may also be configured with other concave and convex arrangements.

A focal length of the fifth lens L5 is f5, and the following relational expression is satisfied: 0.57≤f5/f≤0.84. The limitation of the fifth lens L5 may effectively make a light angle of the camera optical lens 10 smooth and reduce tolerance sensitivity.

A central curvature radius R9 of the object side surface of the fifth lens L5 and the central curvature radius R10 of the image side surface of the fifth lens L5 satisfy the following relational expression: −0.11≤(R9+R10)/(R9−R10)≤0.34. This relational expression defines the shape of the fifth lens L5. Within the range of the relational expression, it is beneficial to correct the problems such as the aberration of off-axis angles.

An on-axis thickness of the fifth lens L5 is d9, and the following relational expression is satisfied: 0.095≤d9/TTL≤0.105. Within the range of relational expression, it is beneficial to achieve ultra-thin property.

The image height at a 1.0 field of view of the camera optical lens 10 is IH, and the total track length of the camera optical lens 10 is TTL, and the following relational expression is satisfied: TTL/IH≤3.14, which is beneficial to achieving ultra-thin property. Optionally,

$$TTL / IH \leq 3. .$$

An F-number of the camera optical lens is defined as FNO, and the following relational expression is satisfied: 2.45≤FNO≤2.77, thereby achieving large aperture and good imaging performance of the camera optical lens.

The camera optical lens of the present disclosure will be described below with examples. The reference signs recited in each example are shown below. The units of the focal length, the on-axis distance, the central curvature radius, and the on-axis thickness are mm.

TTL: a total optical length (an on-axis distance from the object-side surface of the first lens L1 to the image surface S1), in mm.

F-number FNO: a ratio of the effective focal length of the camera optical lens to the entrance pupil diameter.

Image height IH at 1.0 field of view: a height of the field of view corresponding to the active pixel of the sensor (that is, half of the diagonal length of the active pixel area of the sensor).

Field of view FOV at 1.0 field of view: a field of view corresponding to the active pixel of the sensor.

Image height IHm at MIC field of view: a height of the field of view expanding beyond 1.0 field of view for preventing assembly deviation.

Field of view FOVm at MIC field of view: a field of view corresponding to an image height at MIC field of view.

Optionally, the object side surface and/or the image side surface of the lens may also be provided with an inflection point and/or an arrest point, so as to meet high-quality imaging requirements.

Next, the technical solution of the present disclosure will be specifically described with four embodiments. In addition, a comparative embodiment is provided as a reference description, and the technical effects of the present disclosure cannot be achieved when the ranges of the above relational expressions are exceeded.

### First Embodiment

Table 1 and Table 2 show design data of the camera optical lens 10 according to the first embodiment of the present disclosure.

TABLE 1

| | R | d | | nd | | vd | |
|---|---|---|---|---|---|---|---|
| S1 | ∞ | d0= | −0.680 | | | | |
| R1 | 1.931 | d1= | 1.038 | nd1 | 1.4959 | v1 | 81.64 |
| R2 | −20.863 | d2= | 0.682 | | | | |
| R3 | 8.155 | d3= | 0.225 | nd2 | 1.6700 | v2 | 19.39 |
| R4 | 3.106 | d4= | 0.428 | | | | |
| R5 | 50.977 | d5= | 0.225 | nd3 | 1.5444 | v3 | 55.82 |
| R6 | 4.236 | d6= | 1.839 | | | | |
| R7 | −3.858 | d7= | 0.230 | nd4 | 1.5444 | v4 | 55.82 |
| R8 | 7.692 | d8= | 0.121 | | | | |
| R9 | 8.714 | d9= | 0.652 | nd5 | 1.6700 | v5 | 19.39 |
| R10 | −7.396 | d10= | 0.354 | | | | |
| R13 | ∞ | d11= | 0.110 | ndg | 1.5168 | vg | 64.17 |
| R14 | ∞ | d12= | 0.546 | | | | |

The meaning of each reference sign is as follows:
S1: aperture;
R: central curvature radius at the center of the optical surface;
R1: central curvature radius of the object side surface of the first lens L1;
R2: central curvature radius of the image side surface of the first lens L1;
R3: central curvature radius of the object side surface of the second lens L2;
R4: central curvature radius of the image side surface of the second lens L2;
R5: central curvature radius of the object side surface of the third lens L3;
R6: central curvature radius of the image side surface of the third lens L3;
R7: central curvature radius of the object side surface of the fourth lens L4;
R8: central curvature radius of the image side surface of the fourth lens L4;
R9: central curvature radius of the object side surface of the fifth lens L5;
R10: central curvature radius of the image side surface of the fifth lens L5;
R11: central curvature radius of the object side surface of the sixth lens L6;
R12: central curvature radius of the image side surface of the sixth lens L6;
R13: central curvature radius of the object side surface of the grating filter GF;
R14: central curvature radius of the image side surface of the grating filter GF;
d: on-axis thickness of the lens or on-axis distance between the lenses;
d0: on-axis distance from the aperture S1 to the object side surface of the first lens L1;
d1: on-axis thickness of the first lens L1;
d2: on-axis distance from the image side surface of the first lens L1 to the object side surface of the second lens L2;
d3: on-axis thickness of the second lens L2;
d4: on-axis distance from the image side surface of the second lens L2 to the object side surface of the third lens L3;
d5: on-axis thickness of the third lens L3;
d6: on-axis distance from the image side surface of the third lens L3 to the object side surface of the fourth lens L4;
d7: on-axis thickness of the fourth lens L4;
d8: on-axis distance from the image side surface of the fourth lens L4 to the object side surface of the fifth lens L5;
d9: on-axis thickness of the fifth lens L5;
d10: on-axis distance from the image side surface of the fifth lens L5 to the object side surface of the grating filter GF;
d11: on-axis thickness of the grating filter GF;
d12: on-axis distance from the image side surface of the grating filter GF to the image plane S1;
nd: refractive index of d line (the d line is green light with a wavelength of 550 nm);
nd1: refractive index of d line of the first lens L1;
nd2: refractive index of d line of the second lens L2;
nd3: refractive index of d line of the third lens L3;
nd4: refractive index of d line of the fourth lens L4;
nd5: refractive index of d line of the fifth lens L5;
ndg: refractive index of d line of the grating filter GF;
vd: Abbe number;
v1: Abbe number of the first lens L1;
v2: Abbe number of the second lens L2;
v3: Abbe number of the third lens L3;
v4: Abbe number of the fourth lens L4;
v5: Abbe number of the fifth lens L5;
vg: Abbe number of the grating filter GF.

Table 2 shows aspheric data of each lens in the camera optical lens 10 according to the first embodiment of the present disclosure.

TABLE 2

| | Conic Coefficient | Aspheric Coefficient | | | | |
|---|---|---|---|---|---|---|
| | k | A4 | A6 | A8 | A10 | A12 |
| R1 | −3.3869E−01 | 2.4012E−03 | −1.0851E−02 | 5.2802E−02 | −1.6286E−01 | 3.4205E−01 |
| R2 | −3.6879E+01 | 6.6869E−03 | 4.0652E−02 | −2.3549E−01 | 8.2627E−01 | −1.9465E+00 |
| R3 | 5.5248E+01 | 3.5130E−03 | 2.6490E−01 | −2.3494E+00 | 1.8192E+01 | −9.5332E+01 |
| R4 | 6.9589E−01 | −1.6574E−02 | 8.8719E−01 | −1.1013E+01 | 1.0418E+02 | −6.5180E+02 |
| R5 | 9.9900E+01 | 5.6586E−02 | 2.4049E−01 | −1.2977E+00 | 1.3384E+01 | −9.4542E+01 |
| R6 | 1.6302E+01 | 8.9835E−02 | 4.0647E−01 | −4.7552E+00 | 4.5761E+01 | −2.9672E+02 |
| R7 | −2.9838E+01 | −1.3174E−01 | 3.3570E−01 | −4.2661E−01 | −5.9539E−01 | 3.1258E+00 |
| R8 | −4.0961E+01 | −2.7577E−01 | 1.3476E+00 | −4.5120E+00 | 9.9980E+00 | −1.5183E+01 |
| R9 | −2.5974E+01 | −2.3179E−01 | 9.9893E−01 | −3.4137E+00 | 7.5087E+00 | −1.0895E+01 |
| R10 | 6.3068E+00 | −7.9083E−02 | 1.8626E−01 | −5.2895E−01 | 9.3552E−01 | −1.0584E+00 |
| | Conic Coefficient | Aspheric Coefficient | | | | |
| | k | A14 | A16 | A18 | A20 | A22 |
| R1 | −3.3869E−01 | −5.1069E−01 | 5.5413E−01 | −4.4057E−01 | 2.5594E−01 | −1.0714E−01 |
| R2 | −3.6879E+01 | 3.2109E+00 | −3.7968E+00 | 3.2546E+00 | −2.0236E+00 | 9.0272E−01 |
| R3 | 5.5248E+01 | 3.4605E+02 | −8.9187E+02 | 1.6528E+03 | −2.2055E+03 | 2.0964E+03 |
| R4 | 6.9589E−01 | 2.8070E+03 | −8.5186E+03 | 1.8406E+04 | −2.8244E+04 | 3.0253E+04 |
| R5 | 9.9900E+01 | 4.4299E+02 | −1.4317E+03 | 3.2694E+03 | −5.3209E+03 | 6.1343E+03 |
| R6 | 1.6302E+01 | 1.3210E+03 | −4.1562E+03 | 9.3901E+03 | −1.5291E+04 | 1.7788E+04 |
| R7 | −2.9838E+01 | −5.5782E+00 | 5.9407E+00 | −4.2267E+00 | 2.0855E+00 | −7.1782E−01 |
| R8 | −4.0961E+01 | 1.6233E+01 | −1.2454E+01 | 6.9261E+00 | −2.7939E+00 | 8.0863E−01 |
| R9 | −2.5974E+01 | 1.0865E+01 | −7.6828E+00 | 3.9233E+00 | −1.4555E+00 | 3.8940E−01 |
| R10 | 6.3068E+00 | 8.2088E−01 | −4.6031E−01 | 1.9292E−01 | −6.1214E−02 | 1.4565E−02 |

| | Conic Coefficient | Aspheric Coefficient | | | |
|---|---|---|---|---|---|
| | k | A24 | A36 | A28 | A30 |
| R1 | −3.3869E−01 | 3.1405E−02 | −6.1055E−03 | 7.0637E−04 | −3.6784E−05 |
| R2 | −3.6879E+01 | −2.8135E−01 | 5.8125E−02 | −7.1483E−03 | 3.9596E−04 |
| R3 | 5.5248E+01 | −1.3819E+03 | 5.9885E+02 | −1.5300E+02 | 1.7402E+01 |
| R4 | 6.9589E−01 | −2.1779E+04 | 9.7824E+03 | −2.3465E+03 | 1.9651E+02 |
| R5 | 9.9900E+01 | −4.8945E+03 | 2.5704E+03 | −7.9914E+02 | 1.1143E+02 |
| R6 | 1.6302E+01 | −1.4411E+04 | 7.7210E+03 | −2.4576E+03 | 3.5165E+02 |
| R7 | −2.9838E+01 | 1.6933E−01 | −2.6107E−02 | 2.3699E−03 | −9.6035E−05 |
| R8 | −4.0961E+01 | −1.6351E−01 | 2.1912E−02 | −1.7470E−03 | 6.2680E−05 |
| R9 | −2.5974E+01 | −7.3321E−02 | 9.2264E−03 | −6.9671E−04 | 2.3868E−05 |
| R10 | 6.3068E+00 | −2.5122E−03 | 2.9471E−04 | −2.0894E−05 | 6.7209E−07 |

For convenience, the aspheric of each lens surface uses the aspheric shown in the following formula (1). However, the present disclosure is not limited to the aspheric polynomial form represented by formula (1).

$$z = ( {cr}^{2} ) / \{ 1 + {[ 1 - ( k + 1 ) ( {c}^{2} {r}^{2} ) ]}^{1 / 2} \} + A 4 {r}^{4} + A 6 {r}^{6} + A 8 {r}^{8} + A 10 {r}^{10} + A 12 {r}^{12} + A 14 {r}^{14} + A 16 {r}^{16} + A 18 {r}^{18} + A 20 {r}^{20} + A 22 {r}^{22} + A 24 {r}^{24} + A 26 {r}^{26} + A 28 {r}^{28} + A 30 {r}^{30} , \qquad ( 1 )$$

where k represents a conic coefficient, A4, A6, A8, A10, A12, A14, A16, A18, A20, A22, A24, A26, A28 and A30 represent aspheric coefficients, c represents a curvature at the center of the optical plane, r represents a vertical distance between a point on the aspheric curve and the optical axis, and z represents a depth of the aspheric (a vertical distance between a point on the aspheric at a distance r from the optical axis and a tangent plane tangent to a vertex on the aspheric optical axis).

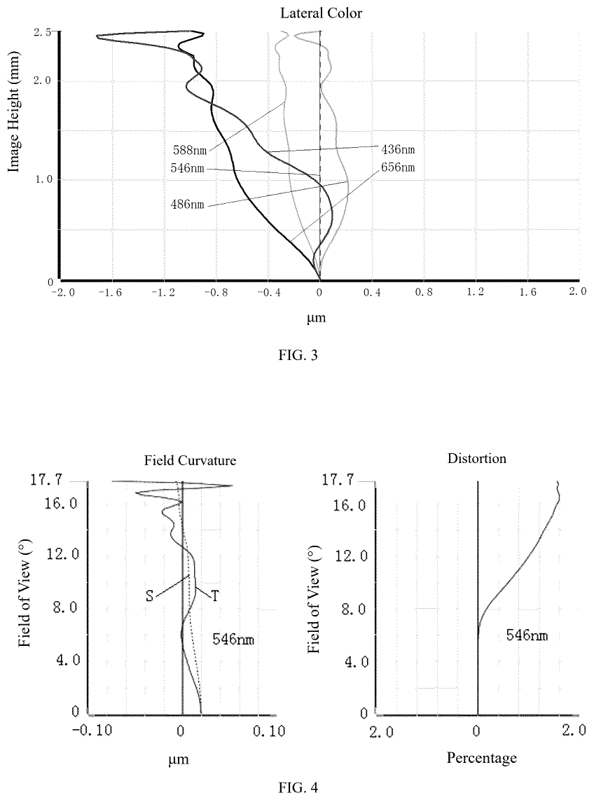

FIG. 2 and FIG. 3 respectively show longitudinal aberration and lateral color of the light at wavelengths of 656 nm, 588 nm, 546 nm, 486 nm, and 436 nm after passing through the camera optical lens 10 according to the first embodiment. FIG. 4 shows a schematic diagram of field curvature and distortion of the light at a wavelength of 546 nm after passing through the camera optical lens 10 according to the first embodiment. In FIG. 4, the field curvature S is a field curvature in a sagittal direction, and T is a field curvature in a meridian direction.

In this embodiment, the entrance pupil diameter ENPD of the camera optical lens 10 is 3.115 mm, the image height IH at the 1.0 field of view is 2.500 mm, and the field of view FOV at the 1.0 field of view is 35.38°, the image height IHm at the MIC field of view is 2.700 mm, and the field of view FOVm at the MIC field of view is 38.21°. The camera optical lens 10 meets the design requirements of large aperture and ultra-thin, effectively correcting both the on-axis and off-axis chromatic aberrations thereof, and has excellent optical characteristics.

### Second Embodiment

The meaning of the reference signs of the second embodiment is the same as that of the first embodiment.

FIG. 5 shows a camera optical lens 20 according to the second embodiment of the present disclosure.

Table 3 and Table 4 show design data of the camera optical lens 20 according to the second embodiment of the present disclosure.

TABLE 3

| | R | d | | nd | | vd | |
|---|---|---|---|---|---|---|---|
| S1 | ∞ | d0= | −0.618 | | | | |
| R1 | 1.931 | d1= | 1.071 | nd1 | 1.4959 | v1 | 81.64 |
| R2 | −19.198 | d2= | 0.702 | | | | |
| R3 | 11.225 | d3= | 0.241 | nd2 | 1.6700 | v2 | 19.39 |
| R4 | 2.926 | d4= | 0.380 | | | | |
| R5 | 41.214 | d5= | 0.157 | nd3 | 1.5444 | v3 | 55.82 |
| R6 | 4.530 | d6= | 2.275 | | | | |
| R7 | −3.464 | d7= | 0.238 | nd4 | 1.5444 | v4 | 55.82 |
| R8 | 7.206 | d8= | 0.106 | | | | |
| R9 | 6.297 | d9= | 0.659 | nd5 | 1.6700 | v5 | 19.39 |
| R10 | −7.797 | d10= | 0.598 | | | | |
| R13 | ∞ | d11= | 0.110 | ndg | 1.5168 | vg | 64.17 |
| R14 | ∞ | d12= | 0.346 | | | | |

Table 4 shows aspheric data of each lens in the camera optical lens 20 according to the second embodiment of the present disclosure.

TABLE 4

| | Conic Coefficient | Aspheric Coefficient | | | | |
|---|---|---|---|---|---|---|
| | k | A4 | A6 | A8 | A10 | A12 |
| R1 | −3.3434E−01 | 2.4406E−03 | −1.0771E−02 | 5.2849E−02 | −1.6283E−01 | 3.4207E−01 |
| R2 | −3.2205E+01 | 6.8018E−03 | 4.1087E−02 | −2.3541E−01 | 8.2634E−01 | −1.9465E+00 |
| R3 | 5.7458E+01 | 7.6566E−03 | 2.6569E−01 | −2.3483E+00 | 1.8194E+01 | −9.5330E+01 |
| R4 | 3.9332E−01 | −3.0506E−02 | 8.8551E−01 | −1.1008E+01 | 1.0417E+02 | −6.5180E+02 |
| R5 | −1.0713E+02 | 4.8293E−02 | 2.3743E−01 | −1.3049E+00 | 1.3390E+01 | −9.4538E+01 |
| R6 | 1.7071E+01 | 9.5828E−02 | 4.0209E−01 | −4.7657E+00 | 4.5756E+01 | −2.9672E+02 |
| R7 | −3.4687E+01 | −1.2915E−01 | 3.3554E−01 | −4.2663E−01 | −5.9540E−01 | 3.1258E+00 |
| R8 | −1.8979E+01 | −2.7947E−01 | 1.3479E+00 | −4.5117E+00 | 9.9980E+00 | −1.5183E+01 |
| R9 | −1.8928E+01 | −2.3109E−01 | 9.9876E−01 | −3.4137E+00 | 7.5087E+00 | −1.0895E+01 |
| R10 | 4.5854E+00 | −7.6581E−02 | 1.8520E−01 | −5.2895E−01 | 9.3554E−01 | −1.0584E+00 |
| | Conic Coefficient | Aspheric Coefficient | | | | |
| | k | A14 | A16 | A18 | A20 | A22 |
| R1 | −3.3434E−01 | −5.1068E−01 | 5.5413E−01 | −4.4057E−01 | 2.5594E−01 | −1.0714E−01 |
| R2 | −3.2205E+01 | 3.2109E+00 | −3.7968E+00 | 3.2546E+00 | −2.0236E+00 | 9.0272E−01 |
| R3 | 5.7458E+01 | 3.4606E+02 | −8.9188E+02 | 1.6528E+03 | −2.2055E+03 | 2.0964E+03 |
| R4 | 3.9332E−01 | 2.8070E+03 | −8.5186E+03 | 1.8406E+04 | −2.8244E+04 | 3.0253E+04 |
| R5 | −1.0713E+02 | 4.4300E+02 | −1.4317E+03 | 3.2695E+03 | −5.3209E+03 | 6.1343E+03 |
| R6 | 1.7071E+01 | 1.3210E+03 | −4.1562E+03 | 9.3901E+03 | −1.5291E+04 | 1.7788E+04 |
| R7 | −3.4687E+01 | −5.5782E+00 | 5.9407E+00 | −4.2267E+00 | 2.0855E+00 | −7.1782E−01 |
| R8 | −1.8979E+01 | 1.6233E+01 | −1.2454E+01 | 6.9261E+00 | −2.7939E+00 | 8.0863E−01 |
| R9 | −1.8928E+01 | 1.0865E+01 | −7.6828E+00 | 3.9233E+00 | −1.4555E+00 | 3.8940E−01 |
| R10 | 4.5854E+00 | 8.2088E−01 | −4.6031E−01 | 1.9292E−01 | −6.1214E−02 | 1.4565E−02 |

| | Conic Coefficient | Aspheric Coefficient | | | |
|---|---|---|---|---|---|
| | k | A24 | A36 | A28 | A30 |
| R1 | −3.3434E−01 | 3.1405E−02 | −6.1055E−03 | 7.0638E−04 | −3.6779E−05 |
| R2 | −3.2205E+01 | −2.8135E−01 | 5.8125E−02 | −7.1482E−03 | 3.9592E−04 |
| R3 | 5.7458E+01 | −1.3819E+03 | 5.9885E+02 | −1.5300E+02 | 1.7400E+01 |
| R4 | 3.9332E−01 | −2.1778E+04 | 9.7822E+03 | −2.3466E+03 | 1.9679E+02 |
| R5 | −1.0713E+02 | −4.8945E+03 | 2.5704E+03 | −7.9914E+02 | 1.1138E+02 |
| R6 | 1.7071E+01 | −1.4411E+04 | 7.7210E+03 | −2.4574E+03 | 3.5144E+02 |
| R7 | −3.4687E+01 | 1.6933E−01 | −2.6107E−02 | 2.3699E−03 | −9.6035E−05 |
| R8 | −1.8979E+01 | −1.6351E−01 | 2.1912E−02 | −1.7470E−03 | 6.2680E−05 |
| R9 | −1.8928E+01 | −7.3321E−02 | 9.2264E−03 | −6.9671E−04 | 2.3868E−05 |
| R10 | 4.5854E+00 | −2.5122E−03 | 2.9471E−04 | −2.0894E−05 | 6.7210E−07 |

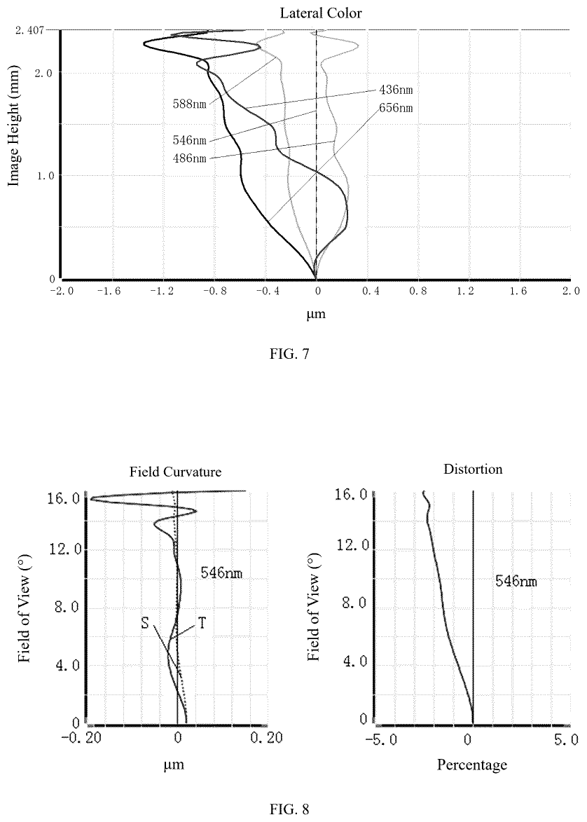

FIG. 6 and FIG. 7 respectively show longitudinal aberration and lateral color of the light at wavelengths of 656 nm, 588 nm, 546 nm, 486 nm, and 436 nm after passing through the camera optical lens 20 according to the second embodiment. FIG. 8 shows field curvature and distortion of the light at a wavelength of 546 nm after passing through the camera optical lens 20 according to the second embodiment. In FIG. 8, the field curvature S is a field curvature in a sagittal direction, and T is a field curvature in a tangential direction.

In this embodiment, the entrance pupil diameter ENPD of the camera optical lens 20 is 3.115 mm, the image height UT at the 1.0 field of view is 2.407 mm, and the field of view FOV at the 1.0 field of view is 32.150, the image height IHm at the MIC field of view is 2.458 mm, and the field of view FOVm at the MIC field of view is 32.840. The camera optical lens 20 meets the design requirements of large aperture and ultra-thin, effectively correcting both the on-axis and off-axis chromatic aberrations thereof, and has excellent optical characteristics.

### Third Embodiment

The meaning of the reference signs of the third embodiment is the same as that of the first embodiment.

FIG. 9 shows a camera optical lens 30 according to the third embodiment of the present disclosure.

Table 5 and Table 6 show design data of the camera optical lens 30 according to the third embodiment of the present disclosure.

TABLE 5

| | R | d | | nd | | vd | |
|---|---|---|---|---|---|---|---|
| S1 | ∞ | d0= | −0.481 | | | | |
| R1 | 1.972 | d1= | 1.000 | nd1 | 1.5500 | v1 | 60.08 |
| R2 | −21.331 | d2= | 0.626 | | | | |
| R3 | 9.704 | d3= | 0.190 | nd2 | 1.6700 | v2 | 19.39 |
| R4 | 2.529 | d4= | 0.420 | | | | |
| R5 | 243.049 | d5= | 0.335 | nd3 | 1.5444 | v3 | 55.82 |
| R6 | 3.800 | d6= | 2.079 | | | | |
| R7 | −3.527 | d7= | 0.320 | nd4 | 1.5444 | v4 | 55.82 |
| R8 | 18.492 | d8= | 0.078 | | | | |
| R9 | 6.757 | d9= | 0.701 | nd5 | 1.6700 | v5 | 19.39 |
| R10 | −6.384 | d10= | 0.807 | | | | |
| R13 | ∞ | d11= | 0.110 | ndg | 1.5168 | vg | 64.17 |
| R14 | ∞ | d12= | 0.473 | | | | |

Table 6 shows aspheric data of each lens in the camera optical lens 30 according to the third embodiment of the present disclosure.

TABLE 6

| | Conic Coefficient | Aspheric Coefficient | | | | |
|---|---|---|---|---|---|---|
| | k | A4 | A6 | A8 | A10 | A12 |
| R1 | −3.3544E−01 | 2.7223E−03 | −1.0505E−02 | 5.2581E−02 | −1.6290E−01 | 3.4203E−01 |
| R2 | −2.7131E+01 | 5.3835E−03 | 4.0155E−02 | −2.3587E−01 | 8.2619E−01 | −1.9465E+00 |
| R3 | 6.0979E+01 | 7.5034E−04 | 2.6513E−01 | −2.3493E+00 | 1.8190E+01 | −9.5332E+01 |
| R4 | 9.7166E−01 | −1.3847E−02 | 8.8763E−01 | −1.0990E+01 | 1.0417E+02 | −6.5173E+02 |
| R5 | −3.4252E+03 | 6.4390E−02 | 2.6182E−01 | −1.2924E+00 | 1.3386E+01 | −9.4562E+01 |
| R6 | 1.5743E+01 | 7.3836E−02 | 3.9590E−01 | −4.7438E+00 | 4.5766E+01 | −2.9673E+02 |
| R7 | −2.5690E+01 | −1.1469E−01 | 3.3261E−01 | −4.2716E−01 | −5.9529E−01 | 3.1258E+00 |
| R8 | −3.4447E+01 | −2.7710E−01 | 1.3466E+00 | −4.5120E+00 | 9.9980E+00 | −1.5183E+01 |
| R9 | −3.3066E+01 | −2.3642E−01 | 1.0014E+00 | −3.4143E+00 | 7.5087E+00 | −1.0895E+01 |
| R10 | 4.4227E+00 | −7.8657E−02 | 1.8788E−01 | −5.2952E−01 | 9.3562E−01 | −1.0584E+00 |
| | Conic Coefficient | Aspheric Coefficient | | | | |
| | k | A14 | A16 | A18 | A20 | A22 |
| R1 | −3.3544E−01 | −5.1069E−01 | 5.5413E−01 | −4.4057E−01 | 2.5594E−01 | −1.0714E−01 |
| R2 | −2.7131E+01 | 3.2109E+00 | −3.7968E+00 | 3.2546E+00 | −2.0236E+00 | 9.0272E−01 |
| R3 | 6.0979E+01 | 3.4604E+02 | −8.9187E+02 | 1.6528E+03 | −2.2055E+03 | 2.0964E+03 |
| R4 | 9.7166E−01 | 2.8069E+03 | −8.5185E+03 | 1.8406E+04 | −2.8244E+04 | 3.0253E+04 |
| R5 | −3.4252E+03 | 4.4303E+02 | −1.4317E+03 | 3.2694E+03 | −5.3210E+03 | 6.1344E+03 |
| R6 | 1.5743E+01 | 1.3210E+03 | −4.1562E+03 | 9.3900E+03 | −1.5291E+04 | 1.7788E+04 |
| R7 | −2.5690E+01 | −5.5782E+00 | 5.9407E+00 | −4.2267E+00 | 2.0855E+00 | −7.1782E−01 |
| R8 | −3.4447E+01 | 1.6233E+01 | −1.2454E+01 | 6.9261E+00 | −2.7939E+00 | 8.0863E−01 |
| R9 | −3.3066E+01 | 1.0865E+01 | −7.6828E+00 | 3.9233E+00 | −1.4555E+00 | 3.8940E−01 |
| R10 | 4.4227E+00 | 8.2088E−01 | −4.6031E−01 | 1.9292E−01 | −6.1214E−02 | 1.4565E−02 |

| | Conic Coefficient | Aspheric Coefficient | | | |
|---|---|---|---|---|---|
| | k | A24 | A36 | A28 | A30 |
| R1 | −3.3544E−01 | 3.1405E−02 | −6.1056E−03 | 7.0637E−04 | −3.6777E−05 |
| R2 | −2.7131E+01 | −2.8135E−01 | 5.8125E−02 | −7.1484E−03 | 3.9599E−04 |
| R3 | 6.0979E+01 | −1.3819E+03 | 5.9884E+02 | −1.5301E+02 | 1.7405E+01 |
| R4 | 9.7166E−01 | −2.1779E+04 | 9.7825E+03 | −2.3461E+03 | 1.9637E+02 |
| R5 | −3.4252E+03 | −4.8945E+03 | 2.5703E+03 | −7.9908E+02 | 1.1138E+02 |
| R6 | 1.5743E+01 | −1.4411E+04 | 7.7210E+03 | −2.4577E+03 | 3.5153E+02 |
| R7 | −2.5690E+01 | 1.6933E−01 | −2.6107E−02 | 2.3699E−03 | −9.6035E−05 |
| R8 | −3.4447E+01 | −1.6351E−01 | 2.1912E−02 | −1.7470E−03 | 6.2680E−05 |
| R9 | −3.3066E+01 | −7.3321E−02 | 9.2264E−03 | −6.9671E−04 | 2.3868E−05 |
| R10 | 4.4227E+00 | −2.5122E−03 | 2.9471E−04 | −2.0894E−05 | 6.7210E−07 |

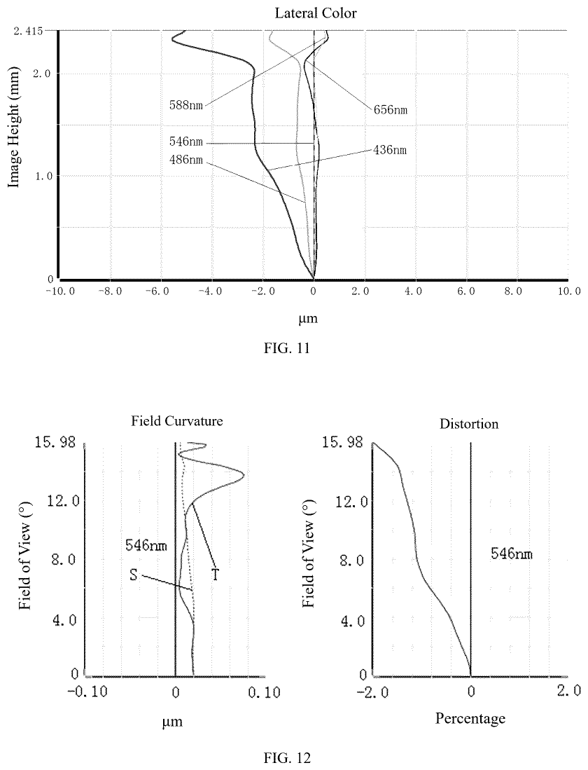

FIG. 10 an FIG. 11 respectively show longitudinal aberration an lateral color of the light at wavelengths of 656 nm, 588 nm, 546 nm, 486 nm, and 436 nm after passing through the camera optical lens 30 according to the third embodiment. FIG. 12 shows field curvature and distortion of the light at a wavelength of 546 nm after passing through the camera optical lens 30 according to the third embodiment. In FIG. 12, the field curvature S is a field curvature in a sagittal direction, and T is a field curvature in a meridional direction.

In this embodiment, the entrance pupil diameter ENPD of the camera optical lens 30 is 3.115 mm, the image height IH at the 1.0 field of view is 2.415 mm, and the field of view FOV at the 1.0 field of view is 31.96°, the image height IHm at the MIC field of view is 2.464 mm, and the field of view FOVm at the MIC field of view is 32.64°. The camera optical lens 30 meets the design requirements of large aperture and ultra-thin, effectively correcting both the on-axis and off-axis chromatic aberrations thereof, and has excellent optical characteristics.

### Fourth Embodiment

The meaning of the reference signs of the fourth embodiment is the same as that of the first embodiment.

FIG. 13 shows a camera optical lens 40 according to the fourth embodiment of the present disclosure.

Table 7 and Table 8 show design data of the camera optical lens 40 according to the fourth embodiment of the present disclosure.

TABLE 7

| | R | d | | nd | | vd | |
|---|---|---|---|---|---|---|---|
| S1 | ∞ | d0= | −0.697 | | | | |
| R1 | 1.938 | d1= | 1.049 | nd1 | 1.4959 | v1 | 81.64 |
| R2 | −22.770 | d2= | 0.707 | | | | |
| R3 | 7.420 | d3= | 0.203 | nd2 | 1.6700 | v2 | 19.39 |
| R4 | 3.160 | d4= | 0.574 | | | | |
| R5 | 80.790 | d5= | 0.200 | nd3 | 1.5444 | v3 | 55.82 |
| R6 | 4.143 | d6= | 1.742 | | | | |
| R7 | −3.216 | d7= | 0.232 | nd4 | 1.5444 | v4 | 55.82 |
| R8 | 10.558 | d8= | 0.121 | | | | |
| R9 | 12.740 | d9= | 0.657 | nd5 | 1.6700 | v5 | 19.39 |
| R10 | −6.378 | d10= | 0.146 | | | | |
| R13 | ∞ | d11= | 0.110 | ndg | 1.5168 | vg | 64.17 |
| R14 | ∞ | d12= | 0.514 | | | | |

Table 8 shows aspheric data of each lens in the camera optical lens 40 according to the fourth embodiment of the present disclosure.

TABLE 8

| | Conic Coefficient | Aspheric Coefficient | | | | |
|---|---|---|---|---|---|---|
| | k | A4 | A6 | A8 | A10 | A12 |
| R1 | −3.4873E−01 | 2.1497E−03 | −1.0619E−02 | 5.3133E−02 | −1.6290E−01 | 3.4204E−01 |
| R2 | −3.4741E+01 | 6.8384E−03 | 4.0687E−02 | −2.3531E−01 | 8.2636E−01 | −1.9465E+00 |
| R3 | 5.0771E+01 | 3.3484E−03 | 2.7111E−01 | −2.3471E+00 | 1.8193E+01 | −9.5333E+01 |
| R4 | 9.1627E−01 | −9.2449E−03 | 8.8937E−01 | −1.1015E+01 | 1.0417E+02 | −6.5181E+02 |
| R5 | 7.8552E+02 | 5.5129E−02 | 2.3889E−01 | −1.3011E+00 | 1.3383E+01 | −9.4542E+01 |
| R6 | 1.6042E+01 | 8.0438E−02 | 4.1526E−01 | −4.7507E+00 | 4.5764E+01 | −2.9673E+02 |
| R7 | −2.5746E+01 | −1.3599E−01 | 3.3103E−01 | −4.2577E−01 | −5.9533E−01 | 3.1258E+00 |
| R8 | −2.2653E+01 | −2.7389E−01 | 1.3458E+00 | −4.5123E+00 | 9.9980E+00 | −1.5183E+01 |
| R9 | −3.0432E+01 | −2.3328E−01 | 9.9843E−01 | −3.4137E+00 | 7.5086E+00 | −1.0895E+01 |
| R10 | 7.2466E+00 | −8.5869E−02 | 1.8778E−01 | −5.2919E−01 | 9.3554E−01 | −1.0584E+00 |
| | Conic Coefficient | Aspheric Coefficient | | | | |
| | k | A14 | A16 | A18 | A20 | A22 |
| R1 | −3.4873E−01 | −5.1068E−01 | 5.5413E−01 | −4.4057E−01 | 2.5594E−01 | −1.0714E−01 |
| R2 | −3.4741E+01 | 3.2109E+00 | −3.7968E+00 | 3.2546E+00 | −2.0236E+00 | 9.0272E−01 |
| R3 | 5.0771E+01 | 3.4605E+02 | −8.9189E+02 | 1.6528E+03 | −2.2055E+03 | 2.0964E+03 |
| R4 | 9.1627E−01 | 2.8070E+03 | −8.5186E+03 | 1.8406E+04 | −2.8244E+04 | 3.0253E+04 |
| R5 | 7.8552E+02 | 4.4300E+02 | −1.4317E+03 | 3.2695E+03 | −5.3209E+03 | 6.1343E+03 |
| R6 | 1.6042E+01 | 1.3210E+03 | −4.1562E+03 | 9.3901E+03 | −1.5291E+04 | 1.7788E+04 |
| R7 | −2.5746E+01 | −5.5782E+00 | 5.9407E+00 | −4.2267E+00 | 2.0855E+00 | −7.1782E−01 |
| R8 | −2.2653E+01 | 1.6233E+01 | −1.2454E+01 | 6.9261E+00 | −2.7939E+00 | 8.0863E−01 |
| R9 | −3.0432E+01 | 1.0865E+01 | −7.6828E+00 | 3.9233E+00 | −1.4555E+00 | 3.8940E−01 |
| R10 | 7.2466E+00 | 8.2088E−01 | −4.6031E−01 | 1.9292E−01 | −6.1214E−02 | 1.4565E−02 |

| | Conic Coefficient | Aspheric Coefficient | | | |
|---|---|---|---|---|---|
| | k | A24 | A36 | A28 | A30 |
| R1 | −3.4873E−01 | 3.1405E−02 | −6.1055E−03 | 7.0635E−04 | −3.6794E−05 |
| R2 | −3.4741E+01 | −2.8135E−01 | 5.8125E−02 | −7.1482E−03 | 3.9597E−04 |
| R3 | 5.0771E+01 | −1.3819E+03 | 5.9886E+02 | −1.5301E+02 | 1.7380E+01 |
| R4 | 9.1627E−01 | −2.1779E+04 | 9.7824E+03 | −2.3465E+03 | 1.9654E+02 |
| R5 | 7.8552E+02 | −4.8945E+03 | 2.5704E+03 | −7.9913E+02 | 1.1145E+02 |
| R6 | 1.6042E+01 | −1.4411E+04 | 7.7210E+03 | −2.4576E+03 | 3.5165E+02 |
| R7 | −2.5746E+01 | 1.6933E−01 | −2.6107E−02 | 2.3699E−03 | −9.6035E−05 |
| R8 | −2.2653E+01 | −1.6351E−01 | 2.1912E−02 | −1.7470E−03 | 6.2680E−05 |
| R9 | −3.0432E+01 | −7.3321E−02 | 9.2264E−03 | −6.9671E−04 | 2.3868E−05 |
| R10 | 7.2466E+00 | −2.5122E−03 | 2.9471E−04 | −2.0894E−05 | 6.7211E−07 |

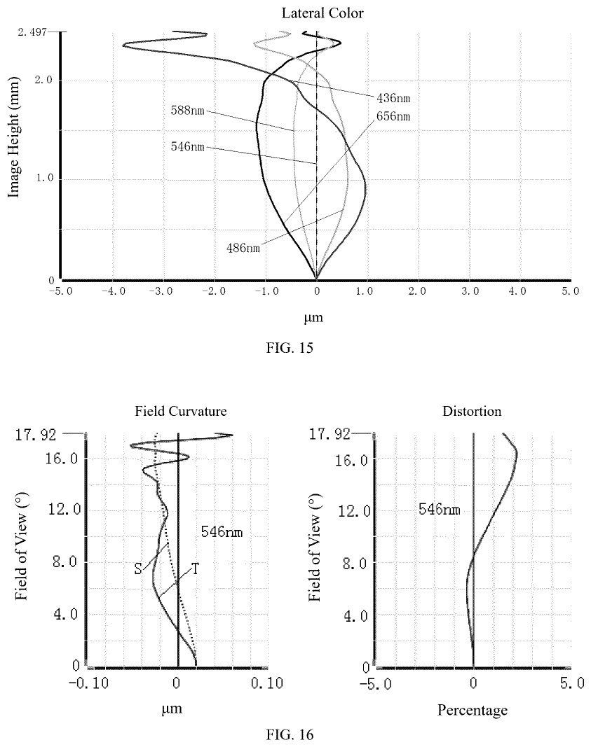

FIG. 14 and FIG. 15 respectively show longitudinal aberration and lateral color of the light at wavelengths of 656 nm, 588 nm, 546 nm, 486 nm, and 436 nm after passing through the camera optical lens 40 according to the fourth embodiment. FIG. 16 shows field curvature and distortion of the light at a wavelength of 546 nm after passing through the camera optical lens 40 according to the third embodiment. In FIG. 16, the field curvature S is a field curvature in a sagittal direction, and T is a field curvature in a meridional direction.

In this embodiment, the entrance pupil diameter ENPD of the camera optical lens 40 is 3.115 mm, the image height IH at the 1.0 field of view is 2.497 mm, and the field of view FOV at the 1.0 field of view is 35.85°, the image height IHm at the MIC field of view is 2.541 mm, and the field of view FOVm at the MIC field of view is 36.54°. The camera optical lens 40 meets the design requirements of large aperture and ultra-thin, effectively correcting both the on-axis and off-axis chromatic aberrations thereof, and has excellent optical characteristics.

Table 11 shows values of various values in the first, second, third and fourth embodiments corresponding to parameters specified in the relational expressions.

### Comparative Embodiment

The meaning of the reference signs of the comparative embodiment is the same as that of the first embodiment.

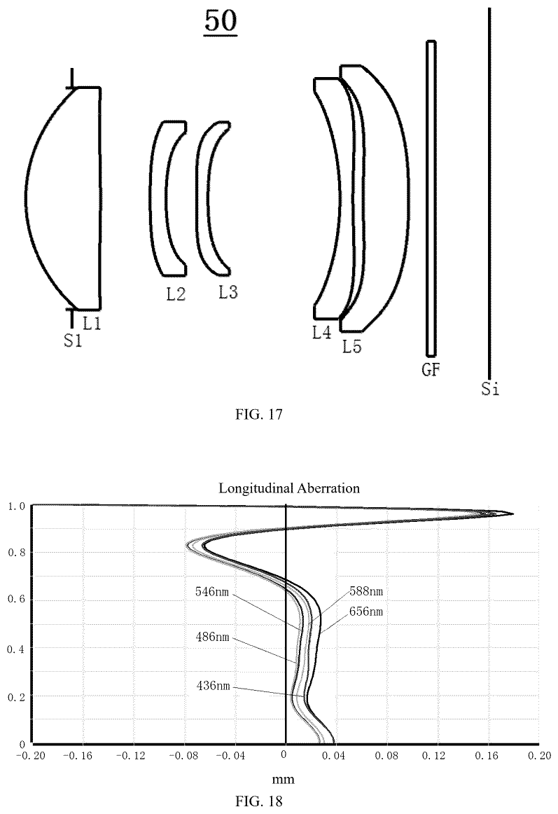

FIG. 17 shows a camera optical lens 50 according to the comparative embodiment.

Table 9 and Table 10 show design data of the camera optical lens 50 according to the comparative embodiment.

TABLE 9

| | R | d | | nd | | vd | |
|---|---|---|---|---|---|---|---|
| S1 | ∞ | d0= | −0.652 | | | | |
| R1 | 1.961 | d1= | 1.051 | nd1 | 1.4959 | v1 | 81.64 |
| R2 | −20.305 | d2= | 0.698 | | | | |
| R3 | 7.974 | d3= | 0.224 | nd2 | 1.6700 | v2 | 19.39 |
| R4 | 3.109 | d4= | 0.430 | | | | |
| R5 | 60.001 | d5= | 0.161 | nd3 | 1.5444 | v3 | 55.82 |
| R6 | 4.305 | d6= | 1.856 | | | | |
| R7 | −3.791 | d7= | 0.182 | nd4 | 1.5444 | v4 | 55.82 |
| R8 | 6.718 | d8= | 0.143 | | | | |
| R9 | 6.166 | d9= | 0.642 | nd5 | 1.6700 | v5 | 19.39 |
| R10 | −8.432 | d10= | 0.261 | | | | |
| R13 | ∞ | d11= | 0.110 | ndg | 1.5168 | vg | 64.17 |
| R14 | ∞ | d12= | 0.765 | | | | |

Table 10 shows aspheric data of each lens in the camera optical lens 50 according to the comparative embodiment.

TABLE 10

| | Conic Coefficient | Aspheric Coefficient | | | | |
|---|---|---|---|---|---|---|
| | k | A4 | A6 | A8 | A10 | A12 |
| R1 | −3.2332E−01 | 2.7705E−03 | −1.0692E−02 | 5.2886E−02 | −1.6271E−01 | 3.4205E−01 |
| R2 | −1.8221E+02 | 6.4505E−03 | 4.0487E−02 | −2.3551E−01 | 8.2639E−01 | −1.9465E+00 |
| R3 | 5.2883E+01 | 8.4915E−03 | 2.6144E−01 | −2.3516E+00 | 1.8191E+01 | −9.5328E+01 |
| R4 | 7.3580E−01 | −1.0664E−02 | 8.9224E−01 | −1.1015E+01 | 1.0418E+02 | −6.5181E+02 |
| R5 | −2.5882E+03 | 5.9179E−02 | 2.4977E−01 | −1.2937E+00 | 1.3385E+01 | −9.4536E+01 |
| R6 | 1.6608E+01 | 7.8928E−02 | 4.0192E−01 | −4.7519E+00 | 4.5733E+01 | −2.9663E+02 |
| R7 | −3.8772E+01 | −1.3658E−01 | 3.3477E−01 | −4.2718E−01 | −5.9560E−01 | 3.1258E+00 |
| R8 | −4.1369E+01 | −2.7789E−01 | 1.3487E+00 | −4.5122E+00 | 9.9978E+00 | −1.5183E+01 |
| R9 | −5.6731E+01 | −2.3518E−01 | 9.9830E−01 | −3.4140E+00 | 7.5086E+00 | −1.0895E+01 |
| R10 | 9.0949E+00 | −7.9778E−02 | 1.8642E−01 | −5.2954E−01 | 9.3564E−01 | −1.0584E+00 |
| | Conic Coefficient | Aspheric Coefficient | | | | |
| | k | A14 | A16 | A18 | A20 | A22 |
| R1 | −3.2332E−01 | −5.1071E−01 | 5.5414E−01 | −4.4057E−01 | 2.5594E−01 | −1.0714E−01 |
| R2 | −1.8221E+02 | 3.2110E+00 | −3.7969E+00 | 3.2546E+00 | −2.0236E+00 | 9.0272E−01 |
| R3 | 5.2883E+01 | 3.4605E+02 | −8.9187E+02 | 1.6528E+03 | −2.2055E+03 | 2.0964E+03 |
| R4 | 7.3580E−01 | 2.8069E+03 | −8.5186E+03 | 1.8406E+04 | −2.8244E+04 | 3.0254E+04 |
| R5 | −2.5882E+03 | 4.4299E+02 | −1.4317E+03 | 3.2694E+03 | −5.3209E+03 | 6.1344E+03 |
| R6 | 1.6608E+01 | 1.3209E+03 | −4.1561E+03 | 9.3901E+03 | −1.5291E+04 | 1.7788E+04 |
| R7 | −3.8772E+01 | −5.5782E+00 | 5.9407E+00 | −4.2267E+00 | 2.0855E+00 | −7.1782E−01 |
| R8 | −4.1369E+01 | 1.6233E+01 | −1.2454E+01 | 6.9261E+00 | −2.7939E+00 | 8.0863E−01 |
| R9 | −5.6731E+01 | 1.0865E+01 | −7.6828E+00 | 3.9233E+00 | −1.4555E+00 | 3.8940E−01 |
| R10 | 9.0949E+00 | 8.2087E−01 | −4.6031E−01 | 1.9292E−01 | −6.1214E−02 | 1.4565E−02 |

| | Conic Coefficient | Aspheric Coefficient | | | |
|---|---|---|---|---|---|
| | k | A24 | A36 | A28 | A30 |
| R1 | −3.2332E−01 | 3.1405E−02 | −6.1055E−03 | 7.0638E−04 | −3.6780E−05 |
| R2 | −1.8221E+02 | −2.8135E−01 | 5.8125E−02 | −7.1483E−03 | 3.9596E−04 |
| R3 | 5.2883E+01 | −1.3819E+03 | 5.9885E+02 | −1.5300E+02 | 1.7401E+01 |
| R4 | 7.3580E−01 | −2.1778E+04 | 9.7818E+03 | −2.3464E+03 | 1.9677E+02 |
| R5 | −2.5882E+03 | −4.8945E+03 | 2.5704E+03 | −7.9914E+02 | 1.1143E+02 |
| R6 | 1.6608E+01 | −1.4411E+04 | 7.7210E+03 | −2.4576E+03 | 3.5163E+02 |
| R7 | −3.8772E+01 | 1.6933E−01 | −2.6107E−02 | 2.3698E−03 | −9.6044E−05 |
| R8 | −4.1369E+01 | −1.6351E−01 | 2.1912E−02 | −1.7470E−03 | 6.2680E−05 |
| R9 | −5.6731E+01 | −7.3321E−02 | 9.2264E−03 | −6.9671E−04 | 2.3868E−05 |
| R10 | 9.0949E+00 | −2.5122E−03 | 2.9471E−04 | −2.0894E−05 | 6.7209E−07 |

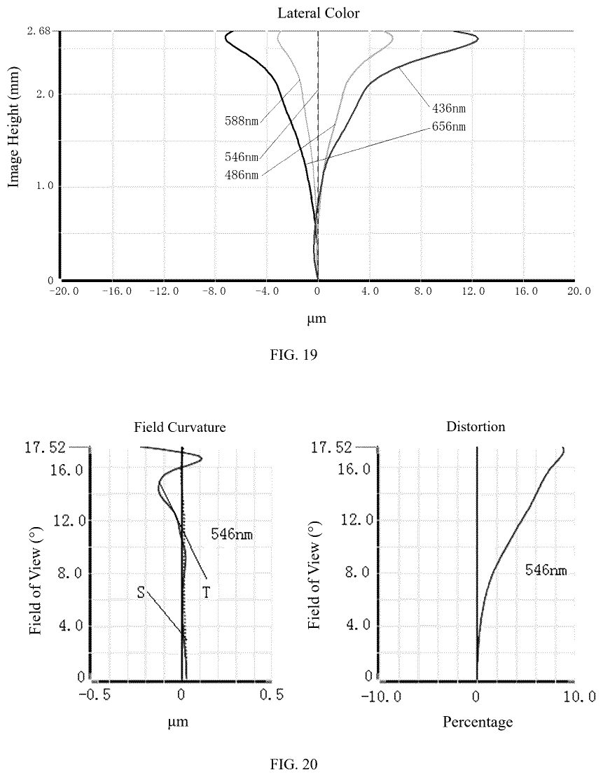

FIG. 18 and FIG. 19 respectively show longitudinal aberration and lateral color of the light at wavelengths of 656 nm, 588 nm, 546 nm, 486 nm, and 436 nm after passing through the camera optical lens 50 according to the comparative embodiment. FIG. 20 shows field curvature and distortion of the light at a wavelength of 546 nm after passing through the camera optical lens 50 according to the comparative embodiment. In FIG. 20, the field curvature S is a field curvature in a sagittal direction, and T is a field curvature in a meridional direction.

Table 11 below lists values corresponding to each relational expression in the comparative embodiment according to the above relational expressions. It is appreciated that, the camera optical lens 50 of the comparative embodiment does not satisfy the above relational expression −2.00≤R9/R10≤−0.80.

In the comparative embodiment, the entrance pupil diameter ENPD of the camera optical lens 50 is 3.115 mm, the image height IH at the 1.0 field of view is 2.680 mm, the field of view FOV at the 1.0 field of view is 35.04°, the image height IHm at the MIC field of view is 2.734 mm, and the field of view FOVm at the MIC field of view is 35.73°. The camera optical lens 50 does not meet the design requirements of small chromatic aberration, small distortion and ultra-thin.

TABLE 11

| Parameters | | | | | |
|---|---|---|---|---|---|
| and | | | | | Compar- |
| Relational | Embodi- | Embodi- | Embodi- | Embodi- | ative Em- |
| Expressions | ment 1 | ment 2 | ment 3 | ment 4 | bodiment |
| d6/d4 | 4.30 | 5.98 | 4.95 | 3.04 | 4.32 |
| R9/R10 | −1.18 | −0.81 | −1.06 | −2.00 | −0.73 |
| (R3 + R4)/ | 2.23 | 1.71 | 1.70 | 2.48 | 2.28 |
| (R3 − R4) | | | | | |
| f | 7.750 | 8.582 | 8.630 | 7.641 | 7.828 |
| f1 | 3.608 | 3.587 | 3.319 | 3.642 | 3.652 |
| f2 | −7.535 | −5.905 | −5.098 | −8.277 | −7.658 |
| f3 | −8.464 | −9.324 | −7.065 | −7.995 | −8.491 |
| f4 | −4.666 | −4.245 | −5.390 | −4.482 | −4.406 |
| f5 | 5.997 | 5.236 | 4.947 | 6.356 | 5.347 |
| FNO | 2.488 | 2.755 | 2.770 | 2.453 | 2.513 |
| TTL | 6.450 | 6.883 | 7.139 | 6.255 | 6.523 |
| IH | 2.5 | 2.407 | 2.415 | 2.497 | 2.68 |
| FOV | 35.38° | 32.15° | 31.96° | 35.85° | 35.04° |

Those skilled in the art should understand that the above embodiments are just specific embodiments for implementing the present disclosure, and in practical applications, various changes may be implemented in form and detail without departing from the spirit and scope of the present disclosure.

What is claimed is:

1. A camera optical lens, comprising five lenses from an object side to an image side:
a first lens having a positive refractive power;
a second lens having a negative refractive power;
a third lens having a negative refractive power;
a fourth lens having a negative refractive power; and
a fifth lens having a positive refractive power,
wherein an on-axis distance from an image side surface of the second lens to an object side surface of the third lens is d4, an on-axis distance from an image side surface of the third lens to an object side surface of the fourth lens is d6, a central curvature radius of an object side surface of the second lens is R3, a central curvature radius of the image side surface of the second lens is R4, a central curvature radius of an object side surface of the fifth lens is R9, and a central curvature radius of an image side surface of the fifth lens is R10, and following relational expressions are satisfied:
$$3. \leq d 6 / d 4 \leq 6. ;$$
$$- 2. \leq R 9 / R 10 \leq - 0.8 ; and$$
$$1.7 \leq ( R 3 + R 4 ) / ( R 3 - R 4 ) \leq 2.5 .$$

2. The camera optical lens as described in claim 1, wherein an Abbe number of the first lens is v1, and a following relational expression is satisfied:
$$60. \leq v 1 \leq 82. .$$

3. The camera optical lens as described in claim 1, wherein a focal length of the third lens is f3, and a focal length of the fourth lens is f4, and a following relational expression is satisfied:
$$1.2 \leq f 3 / f 4 \leq 2.4 .$$

4. The camera optical lens as described in claim 1, wherein an object side surface of the first lens is convex in a paraxial region, and an image side surface of the first lens is convex in the paraxial region, and
wherein a focal length of the camera optical lens is f, a focal length of the first lens is f1, a central curvature radius of the object side surface of the first lens is R1, a central curvature radius of the image side surface of the first lens is R2, an on-axis thickness of the first lens is d1, and a total track length of the camera optical lens is TTL, and following relational expressions are satisfied:
$$0.38 \leq f 1 / f \leq 0.48 ;$$
$$- 0.85 \leq ( R 1 + R 2 ) / ( R 1 - R 2 ) \leq - 0.81 ; and$$
$$0.14 \leq d 1 / TTL \leq 0.168 .$$

5. The camera optical lens as described in claim 1, wherein the object side surface of the second lens is convex in a paraxial region, and the image side surface of the second lens is concave in the paraxial region, and
wherein a focal length of the camera optical lens is f, a focal length of the second lens is f2, an on-axis thickness of the second lens is d3, and a total track length of the camera optical lens is TTL, and following relational expressions are satisfied:
$$- 1.09 \leq f 2 / f \leq - 0.59 ; and$$
$$0.026 \leq d 3 / TTL \leq 0.035 .$$

6. The camera optical lens as described in claim 1, wherein the object side surface of the third lens is convex in a paraxial region, and the image side surface of the third lens is concave in the paraxial region, and
wherein a focal length of the camera optical lens is f, a focal length of the third lens is f3, a central curvature radius of the object side surface of the third lens is R5, a central curvature radius of the image side surface of the third lens is R6, an on-axis thickness of the third lens is d5, and a total track length of the camera optical lens is TTL, and following relational expressions are satisfied:
$$- 1.1 \leq f 3 / f \leq - 0.81 ;$$
$$1.03 \leq ( R 5 + R 6 ) / ( R 5 - R 6 ) \leq 1.25 ; and$$
$$0.022 \leq d 5 / TTL \leq 0.047 .$$

7. The camera optical lens as described in claim 1, wherein the object side surface of the fourth lens is concave in a paraxial region, and an image side surface of the fourth lens is concave in the paraxial region, and
wherein a focal length of the camera optical lens is f, a focal length of the fourth lens is f4, a central curvature radius of the object side surface of the fourth lens is R7, a central curvature radius of the image side surface of the fourth lens is R8, an on-axis thickness of the fourth lens is d7, and a total track length of the camera optical lens is TTL, and following relational expressions are satisfied:
$$- 0.63 \leq f 4 / f \leq - 0.49 ;$$
$$- 0.69 \leq ( R 7 + R 8 ) / ( R 7 - R 8 ) \leq - 0.33 ; and$$
$$0.034 \leq d 7 / TTL \leq 0.045 .$$

8. The camera optical lens as described in claim 1, wherein the object side surface of the fifth lens is convex in a paraxial region, and the image side surface of the fifth lens is convex in the paraxial region, and
wherein a focal length of the camera optical lens is f, a focal length of the fifth lens is f5, an on-axis thickness of the fifth lens is d9, and a total track length of the camera optical lens is TTL, and following relational expressions are satisfied:
$$0.57 \leq f 5 / f \leq 0.84 ;$$
$$- 0.11 \leq ( R 9 + R 10 ) / ( R 9 - R 10 ) \leq 0.34 ; and$$
$$0.095 \leq d 9 / TTL \leq 0.105 .$$

9. The camera optical lens as described in claim 1, wherein an F-number of the camera optical lens is FNO, and a following relational expression is satisfied:
$$2.45 \leq FNO \leq 2.77 .$$

10. The camera optical lens as described in claim 1, wherein the first lens is made of glass.

11. The camera optical lens as described in claim 3, wherein the focal length of the third lens is f3, and the focal length of the fourth lens is f4, and a following relational expression is satisfied:
$$1.3 \leq f 3 / f 4 \leq 2.2 .$$
